(19) United States
(12) Patent Application Publication
(10) Pub. No.: US 2014/0041247 A1
(43) Pub. Date: Feb. 13, 2014

(54) Grain Aeration System

(71) Applicant: Gary A. Schreiner, Saskatoon (CA)

(72) Inventor: Gary A. Schreiner, Saskatoon (CA)

(73) Assignee: GATCO MANUFACTURING INC., Saskatoon (CA)

(21) Appl. No.: 13/612,101

(22) Filed: Sep. 12, 2012

(30) Foreign Application Priority Data
Jul. 27, 2012 (CA) 2783927

(51) Int. Cl. F26B 25/06

(52) U.S. Cl. 34/201

(57) ABSTRACT

An aeration system for aerating particulate materials disposed in a storage bin. A plurality of elongated hollow wall aerators is provided. Each wall aerator is disposed inside the storage bin having a substantially vertical orientation and is mounted adjacent to an inside surface of a wall of the storage bin. Each wall aerator has at least an opening for transmitting air from inside the wall aerator to the particulate materials. Each of a plurality of convection air inlets is connected to a bottom portion of a respective wall aerator. Each convection air inlet provides outside air to the respective wall aerator through a respective opening disposed in a bottom portion of the storage bin using natural convection.

This application claims priority to Canadian Patent Application Serial No. ______, filed on Jul. 27, 2012 and entitled Grain Aeration System, naming Gary A. Schreiner as inventor; the entire contents of such application are incorporated by reference herein.

### FIELD

The present invention relates to aeration of particulate materials, and more particularly to an aeration system for aerating particulate materials disposed in a storage bin based on natural convection.

### BACKGROUND

After harvest grain such as, for example, wheat, rye, barley, canola, soybeans, is stored in storage bins—on site at a farm or in large commercial storage facilities—prior distribution for processing or sale. Typically, the grain is stored in the storage bins during fall and winter.

Temperature changes due to changing seasons result in an unequal temperature distribution within the grain stored inside the storage bin causing natural convection of air through the grain and causing moisture to migrate therewith. The moisture then gathers in the top portion of the stored grain causing it to spoil. Depending on the temperature and the moisture content of the grain spoilage occurs within weeks or even days.

To prevent spoilage of grain stored in storage bins grain aeration systems or grain drying systems are employed for providing outside air into and through the stored grain. State of the art aeration systems are relatively complex and difficult to install, especially when installed on site as a retrofit to existing storage bins. Furthermore, state of the art grain aeration systems employing natural convection do not provide substantially complete aeration of the contents of the storage bin.

It is desirable to provide a natural convection based aeration system for aerating particulate materials disposed in a storage bin that is simple and easy to install as a retrofit.

It is also desirable to provide a natural convection based aeration system for aerating particulate materials disposed in a storage bin that provides a more complete aeration of the particulate materials.

It is also desirable to provide a natural convection based aeration system for aerating particulate materials disposed in a storage bin that can be combined with an existing aeration system to improve the aeration of the particulate materials.

It is also desirable to provide a natural convection based aeration system for aerating particulate materials disposed in a storage bin that is operable when the storage bin is only partially filled.

### SUMMARY

Accordingly, one object of the present invention is to provide a natural convection based aeration system for aerating particulate materials disposed in a storage bin that is simple and easy to install as a retrofit.

Another object of the present invention is to provide a natural convection based aeration system for aerating particulate materials disposed in a storage bin that provides a more complete aeration of the particulate materials.

Another object of the present invention is to provide a natural convection based aeration system for aerating particulate materials disposed in a storage bin that can be combined with an existing aeration system to improve the aeration of the particulate materials.

Another object of the present invention is to provide a natural convection based aeration system for aerating particulate materials disposed in a storage bin that is operable when the storage bin is only partially filled.

According to one aspect of the present invention, there is provided an aeration system for aerating particulate materials disposed in a storage bin. A plurality of elongated hollow wall aerators is provided. Each wall aerator is disposed inside the storage bin having a substantially vertical orientation and is mounted adjacent to an inside surface of a wall of the storage bin. Each wall aerator has at least an opening for transmitting air from inside the wall aerator to the particulate materials. Each of a plurality of convection air inlets is connected to a bottom portion of a respective wall aerator. Each convection air inlet provides outside air to the respective wall aerator through a respective opening disposed in a bottom portion of the storage bin using natural convection.

According to another aspect of the present invention, there is provided an aeration system for aerating particulate materials disposed in a storage bin. A plurality of elongated hollow wall aerators is provided. Each wall aerator is disposed inside the storage bin having a substantially vertical orientation and is mounted adjacent to an inside surface of a wall of the storage bin. Each wall aerator has at least an opening for transmitting air from inside the wall aerator to the particulate materials. Each of a plurality of convection air inlets is connected to a bottom portion of a respective wall aerator. Each convection air inlet provides outside air to the respective wall aerator through a respective opening disposed in a bottom portion of the storage bin using natural convection. Each wall aerator has at least a damper disposed therein to enable aeration of the particulate materials when the storage bin is only partially filled.

An advantage of the present invention is that it provides a natural convection based aeration system for aerating particulate materials disposed in a storage bin that is simple and easy to install as a retrofit.

A further advantage of the present invention is that it provides a natural convection based aeration system for aerating particulate materials disposed in a storage bin that provides a more complete aeration of the particulate materials.

A further advantage of the present invention is that it provides a natural convection based aeration system for aerating particulate materials disposed in a storage bin that can be combined with an existing aeration system to improve the aeration of the particulate materials.

A further advantage of the present invention is that it provides a natural convection based aeration system for aerating particulate materials disposed in a storage bin that is operable when the storage bin is only partially filled.

### BRIEF DESCRIPTION OF THE DRAWINGS

An embodiment of the present invention is described below with reference to the accompanying drawings, in which:

FIGS. 1a to 1c are simplified block diagrams illustrating a perspective view of an aeration system according to an embodiment of the invention with the aeration system alone, combined with a central aerator, and combined with a floor aerator, respectively;

FIGS. 2a to 2d are simplified block diagrams illustrating a cross sectional view of convectional air flow in the storage bin for: the aeration system according to an embodiment of the invention alone; the aeration system according to the disclosed embodiment of the invention combined with a central aerator; a floor aeration system; and the floor aeration system combined with the aeration system according to the disclosed embodiment of the invention, respectively;

FIGS. 3a and 3b are simplified block diagrams illustrating a perspective front view and a perspective back view, respectively, of a wall aerator of the aeration system according to an embodiment of the invention;

FIG. 3c is a simplified block diagram illustrating a cross sectional view of a wall aerator of the aeration system according to an embodiment of the invention;

FIGS. 3d and 3e are simplified block diagrams illustrating a perforated screen and a louvered screen, respectively, for use with the wall aerator of the aeration system according to an embodiment of the invention;

FIGS. 4a and 4b are simplified block diagrams illustrating a cross sectional view and a perspective view, respectively, of a convection air inlet of the aeration system according to an embodiment of the invention;

FIGS. 4c and 4d are simplified block diagrams illustrating a perspective view of a damper assembly in a closed and an open position, respectively, of the aeration system according to an embodiment of the invention;

FIG. 4e is a simplified block diagram illustrating a cross sectional view of the damper assembly shown in FIGS. 4c and 4d; and,

FIG. 5 is a simplified block diagram illustrating a perspective view of central aerator for use with the aeration system according to an embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments herein below is with reference to an aeration system for aerating grain disposed in a storage bin, it will become evident to those skilled in the art that the embodiments of the invention are not limited thereto, but are also applicable for aerating numerous other stored particulate materials where a reduction in moisture content and/or a substantially equal temperature distribution within the stored particulate materials is desirable.

Furthermore, while the description of the embodiments herein below is with reference to an aeration system for aerating grain disposed in a storage bin having a circular cross section, it will become evident to those skilled in the art that the embodiments of the invention are not limited thereto, but are also applicable for storage bins having other cross sections such as, for example, cross sections of square or rectangular shape.

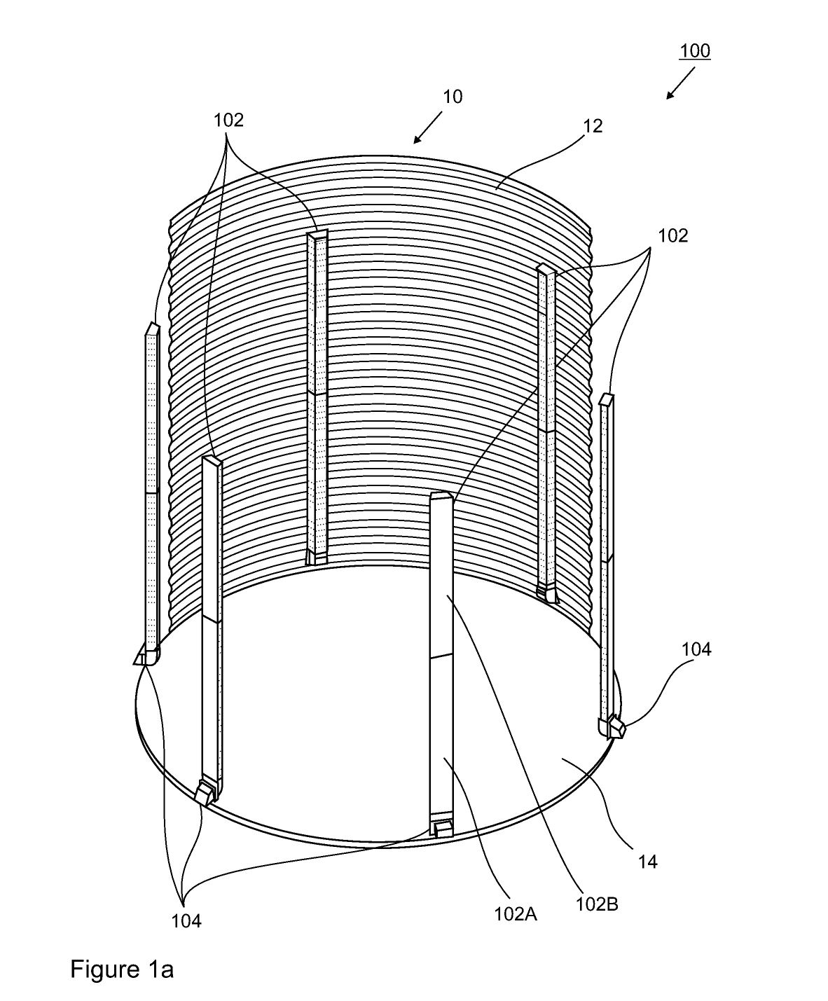

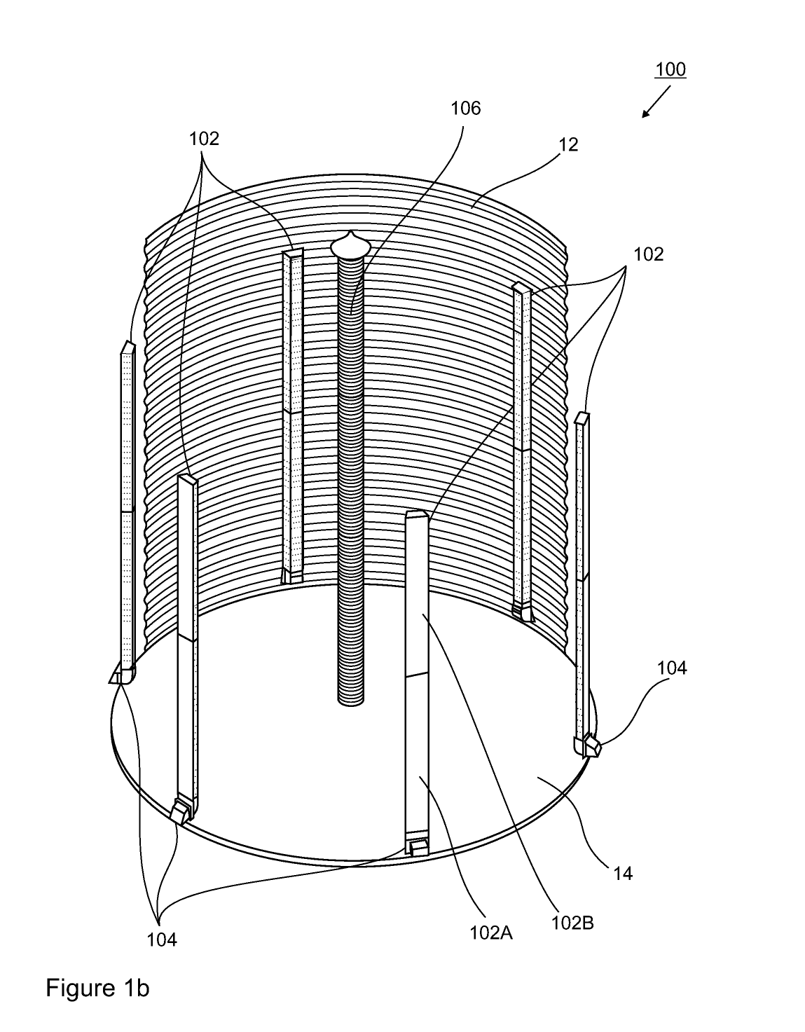

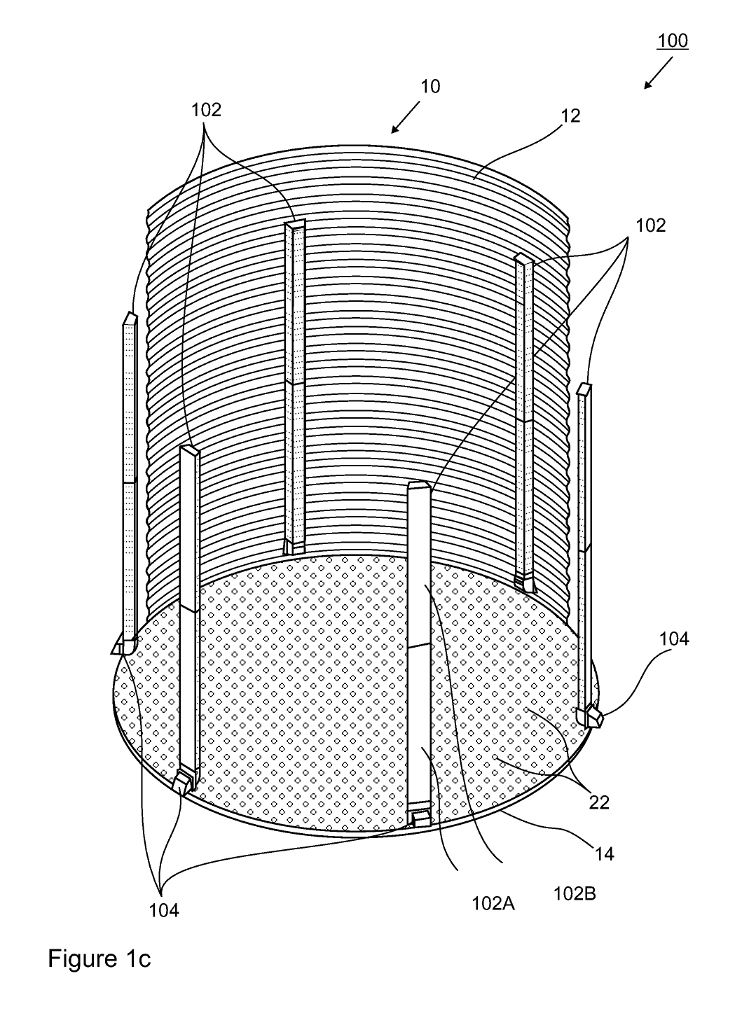

Referring to FIG. 1a, an aeration system 100 for aerating grain disposed in a storage bin 10 according to an embodiment of the invention is provided. The aeration system 100 comprises a plurality of elongated hollow wall aerators 102 mounted adjacent to the inside surface of wall 12 of the storage bin 10, in one case, such that the wall aerators 102 are structurally supported by the wall 12. The wall aerators 102 can be disposed such that the distance between the wall aerators 102 is substantially equal to ensure approximately equal aeration of the grain. Each wall aerator 102 has at least an opening for transmitting air from inside the aerator 102 to the grain as will be described in more detail herein below. A bottom portion of each wall aerator 102 is connected to a convection air inlet 104 for providing outside air to the respective wall aerator 102 through a respective opening disposed in a bottom portion of the wall 12 of the storage bin 10 using natural convection. The convection air inlets 104 can be disposed in proximity to floor 14 of the storage bin 10. Alternatively, the convection air inlets 104 are adapted for providing outside air through a respective opening disposed in the floor 14 of the storage bin 10, for example, when the floor 14 is disposed above ground and/or forms a hopper.

Optionally, the aeration system 100 is combined with other aeration systems, for example, as a retrofit to improve the aeration of the grain. Referring to FIGS. 1b and 1c, the aeration system 100 is combined, for example, with an elongated hollow central aerator 106 or with a floor aerator 22, respectively.

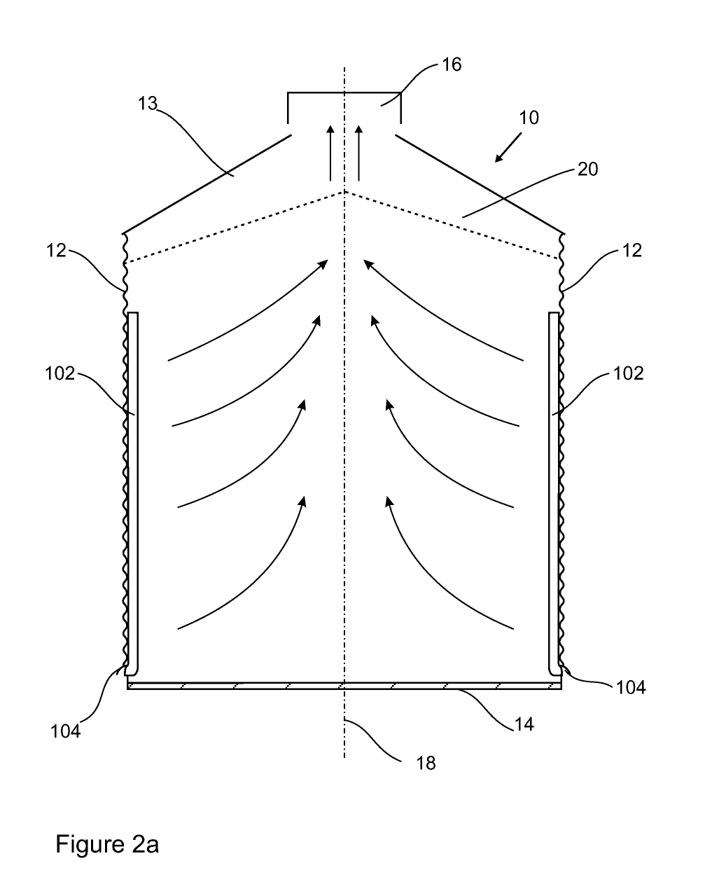

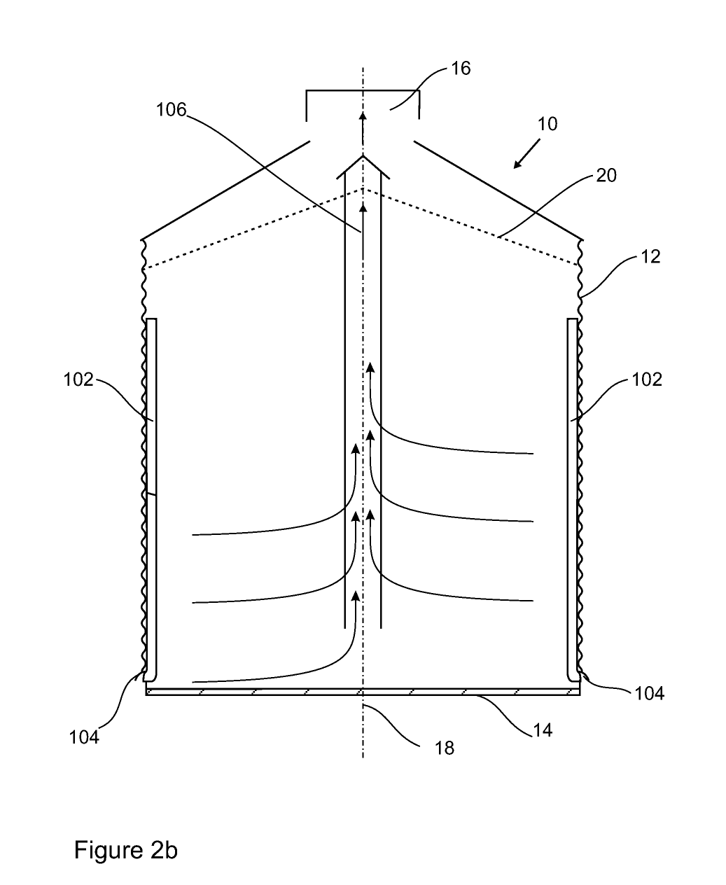

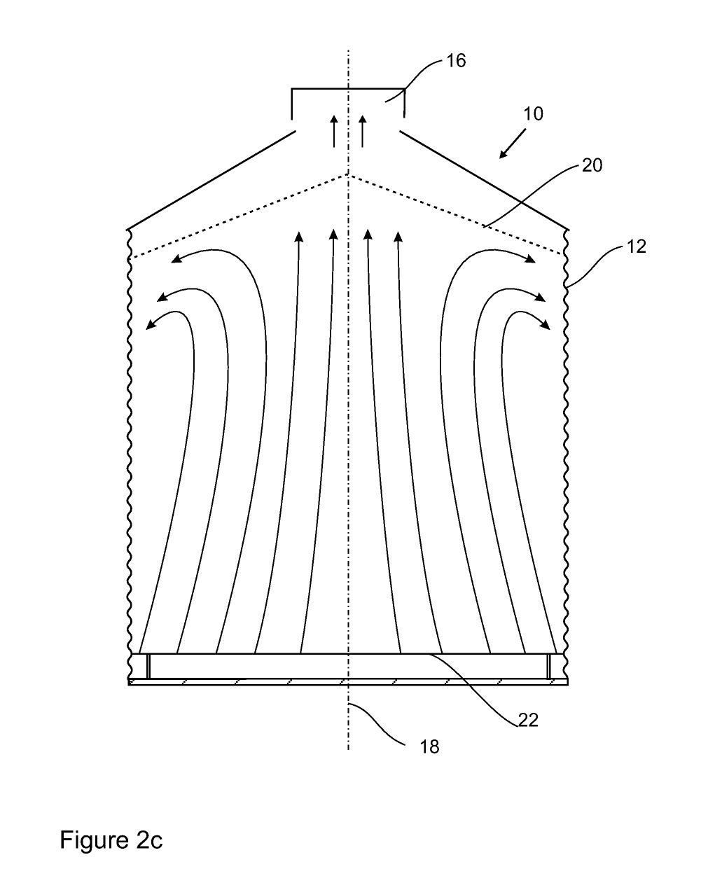

Referring to FIGS. 2a to 2d, a cross sectional view through a filled state of the art grain storage bin 10 is shown, illustrating natural convection with: the aeration system 100 only, as illustrated in FIG. 1athe aeration system 100 combined with the central aerator 106, as illustrated in FIG. 1b; the floor aerator 22 only; and the aeration system 100 combined with the floor aerator 22, as illustrated in FIG. 1c, respectively. Grain is disposed within the storage bin 10 to a fill level 20. Cooler temperatures during fall and winter cause an unequal temperature distribution within the stored grain with zones of lower temperature located in proximity to the outside walls of the storage bin 10 and zones of higher temperature 18 located in proximity to the center of the storage bin 10. The unequal temperature distribution causes a natural convection of air to occur inside the stored grain with the warmer air rising in the center 18 and being vented to the outside via ventilator 16. Cooler outside air is provided by the wall aerators 102 from the outside, indicated by the arrows in FIG. 2a. Tests in storage bins filled with coarse grain have revealed that adding the central aerator 106 causes the air flow to move substantially horizontally from the wall aerators 102 to the central aerator 106, i.e. the air takes the shortest path through the grain to an opening such as the center aerator 106, as indicated by the arrows in FIG. 2b. Employment of the central aerator 106 improves the aeration of the grain disposed in the center bottom portion of the storage bin 10. FIGS. 2c and 2d illustrate the air flow using floor aeration only and the combination with the aeration system 100, respectively. Employment of only the floor aerator 22 causes, as the drying front progresses upward, heavy moisture laden air to be drawn towards the wall 12 of the storage bin 10 where it condenses, resulting in moisture damage to the grain near the wall 12. Employment of the wall aerators 102 provides aeration to the area near the wall 12, preventing collection of moisture and thus moisture damage to the grain.

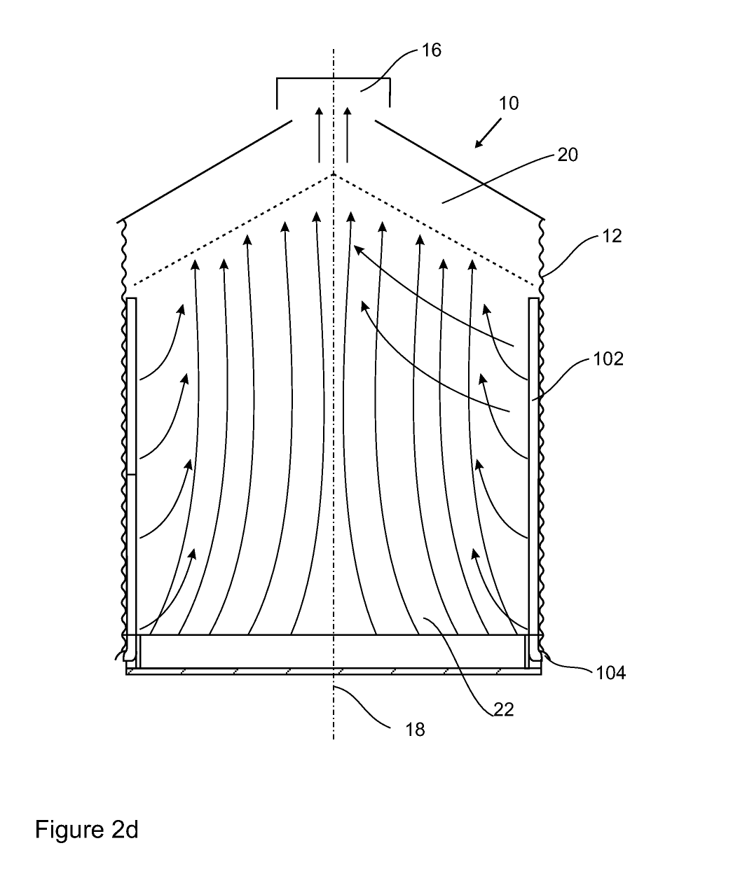

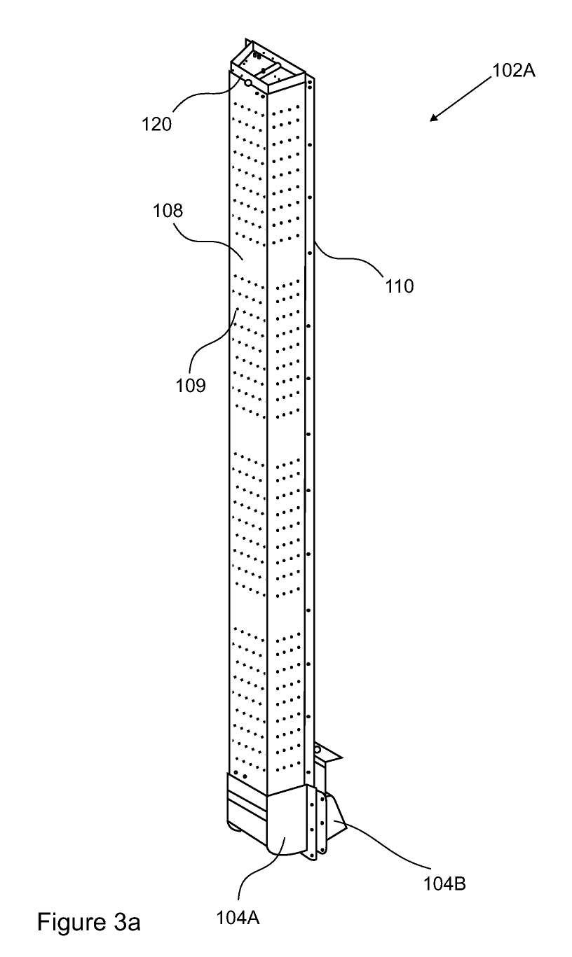

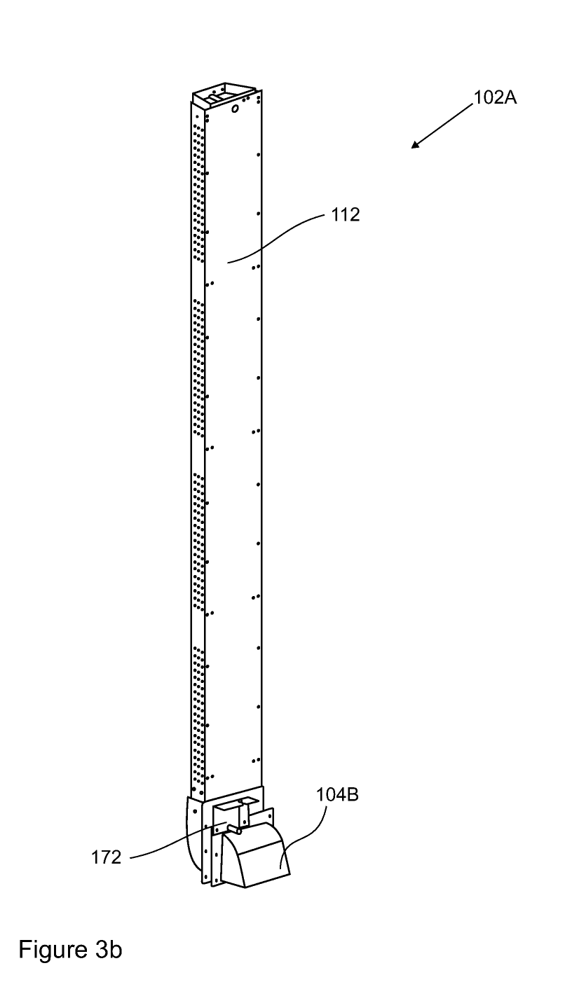

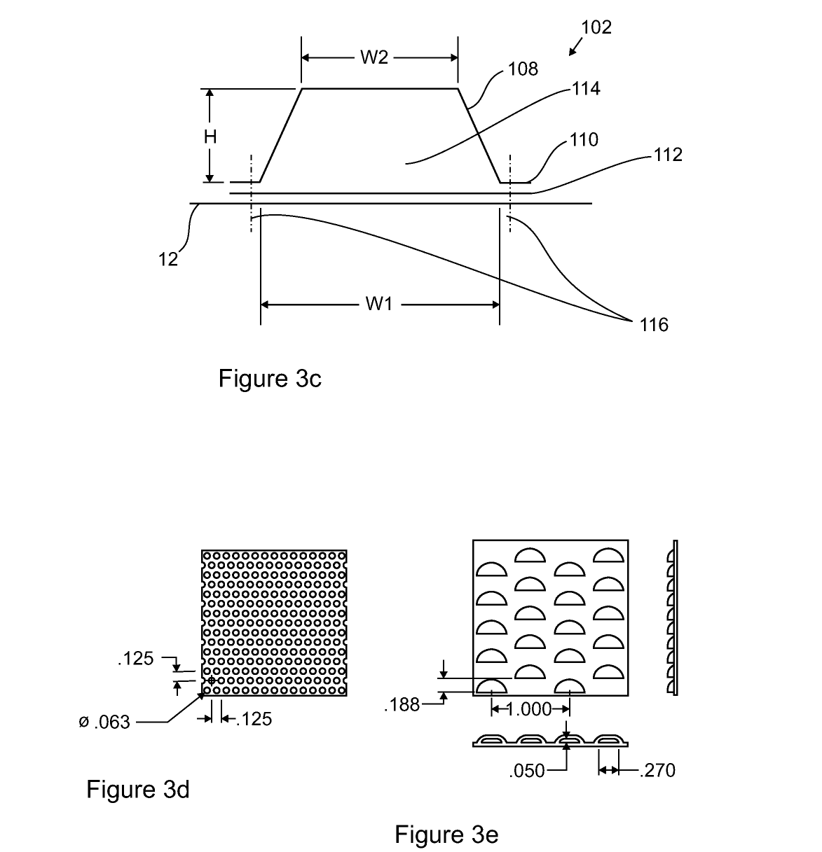

Referring to FIGS. 3a to 3e, a wall aerator 102 according to an embodiment of the invention is shown. The wall aerator 102 comprises a back member 112 facing the inside wall 12 of the storage bin 10 and a front member 108 facing the center of the storage bin 10. The back member 112 can be shaped such that a portion of a contact surface of back member 112 is in touching contact with the wall 12 of the storage bin 10 for structural support when mounted thereto. In typical applications, the width W1 of the contact surface of the back member 112 is substantially smaller than the diameter D of the storage bin 10, i.e. provision of a flat contact surface enables sufficient contact area for structural support of the wall aerator 102 by the wall 12 of the storage bin 10. The back member 112 is mounted to the wall 12 using, for example, machine screws through the bin wall at locations 116, as indicated in FIG. 3c, substantially facilitating installation. Optionally, apertures are disposed in the contact surface of the back member 112 at predetermined locations 110 for accommodating the machine screws therein. The front member 108 is mounted to the back member 112 at flanges 110 using, for example, sheet metal screws or a clamping mechanism. Optionally a sealing member is disposed between respective flanges of the back member 112 and the front member 108.

The openings 109 are sized such that airflow from inside 114 the wall aerator 102 to the particulate materials is enabled while transmission of the particulate materials into the wall aerator 102 is substantially prevented. For use with grain storage bins the wall aerator 102 can comprise a perforated screen 109 having round perforations in a staggered pattern and having the dimensions (in inches) as illustrated in FIG. 3d, or a louvered screen having the dimensions (in inches) as illustrated in FIG. 3e, but is not limited thereto. The perforations are provided using state of the art manufacturing processes such as CNC punching. Alternatively, the wall aerator 102 comprises larger openings disposed on the front member 108 with a screen having perforations of appropriate size. The screen is, for example, made from wire mesh of appropriate dimensions and mounted to the front member 108 using a supporting frame structure. Further alternatively, the perforations are disposed only on the front surface portion or the side surface portions of the front member 108.

Each of the wall aerators 102 can comprise a plurality of members, for example, a bottom member 102A and a top member 102B to facilitate transport and installation, particularly when employed as a retrofit. The shorter top and bottom members are more easily moved through a manhole of the storage bin 10 as well as handled inside the storage bin 10 during installation.

The back member 112, the front member 108, the ring member 120, and a cap mounted to the top end of the top section 102B are made of, for example, commercially available sheet metal—appropriate steel such as galvanized steel or aluminum—or suitable plastic material such as PVC using standard plastic molding techniques.

For example, the aeration system 100 has been implemented for aerating a grain storage bin 10 as illustrated in FIGS. 1a to 1c and 2a to 2d having circular floor 14 with a diameter of approximately 16 feet and a wall 12 having a height of approximately 18 feet. Six wall aerators 102 are mounted to the inside surface of wall 12 of the storage bin 10 in an equidistant fashion. Each wall aerator 102 comprises a bottom member 102A and one or more top members 102B with each section having a length of 8 feet and cross sectional dimensions—as illustrated in FIG. 3c—of: W1=8⅝ inches; W2=6 inches; and H=4⅞ inches. With these dimensions each section has an area of 760 square inches that can be perforated or louvered, resulting in a maximum open area of: 175 square inches using a 23% perforated screen; or 46 square inches using a 6% louvered screen. As is evident, other numbers of wall aerators 102 having different numbers of members and different dimensions are employable depending on the size and shape of the storage bin 10 as well as the type of particulate materials to be stored therein and the weather conditions—such as, for example, temperature and humidity—the storage bin is expected to be exposed to. The aeration system 100 is designed employing standard engineering technologies used for designing storage bins.

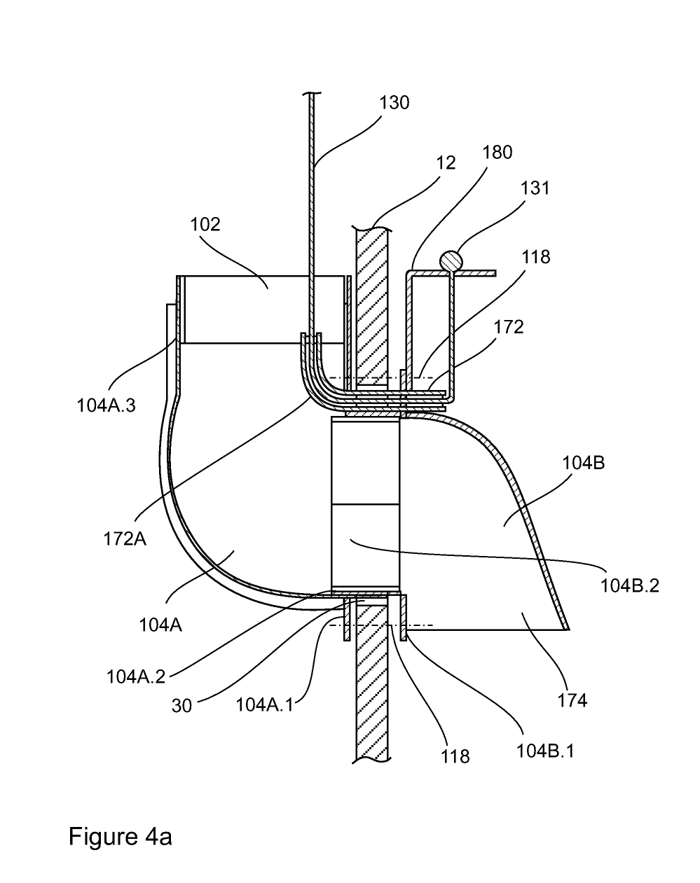

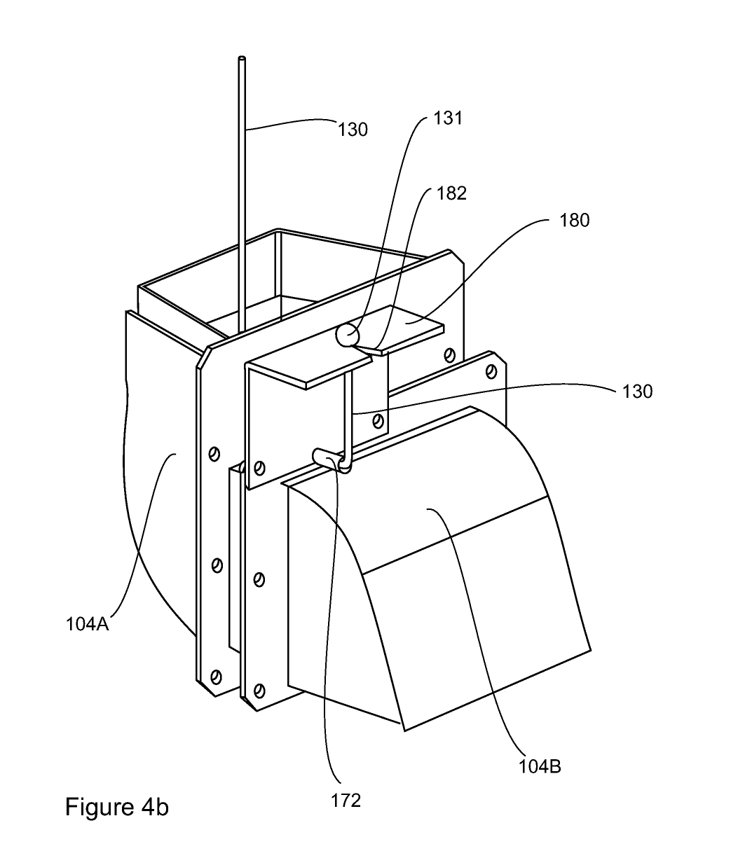

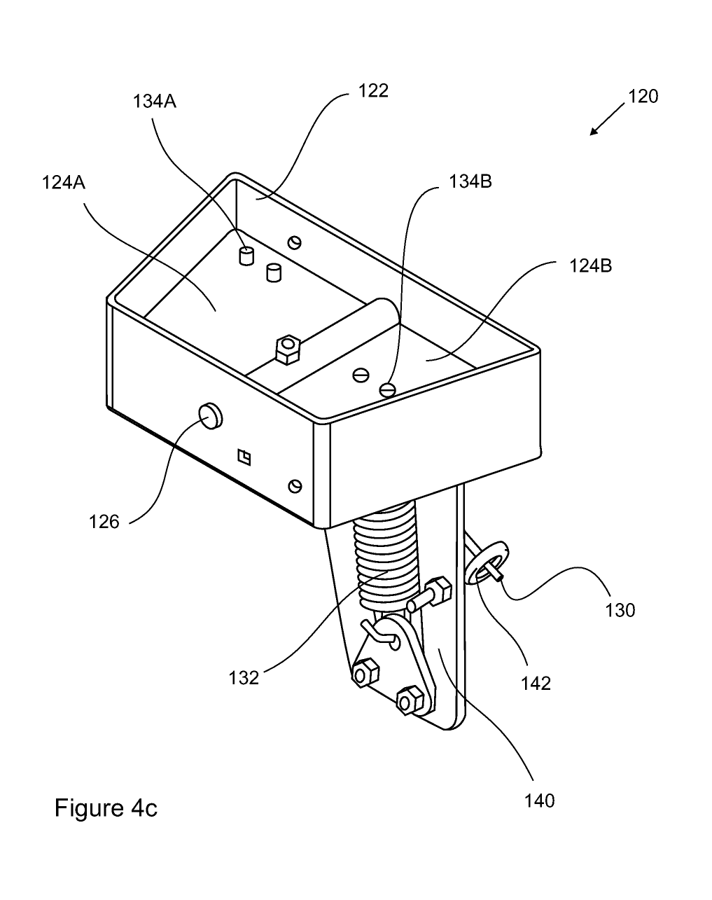

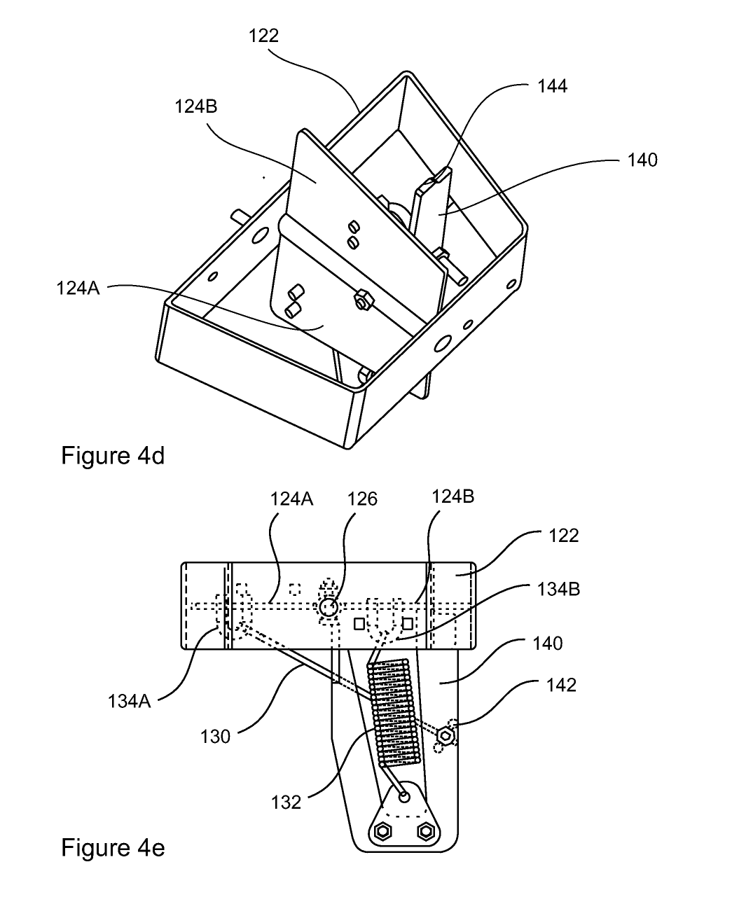

A bottom portion of each wall aerator 102 is connected to the convection air inlet 104, for example, as illustrated in FIGS. 4a and 4b, for providing outside air to the wall aerator 102 through a respective opening 30 disposed in a bottom portion of the wall 12 of the storage bin 10 using natural convection. The convection air inlet 104 can comprise an elbow section 104A mounted to the wall 12 inside the storage bin 10 and a cover section 104B mounted to the wall 12 outside the storage bin 10 in conventional manner using, for example, screw bolts 118. For example, the elbow section 104A and the cover section 104B each comprise a mounting plate 104A.1, 104B.1 while the elbow section 104A has aperture 104A.2 and cover section 104B has extension 104B.2 for being snugly accommodated in the aperture 104A.2. The mounting plates 104A.1, 104B.1 are mounted to the wall 12 such that the extension 104B.2 is accommodated in the opening 30 disposed in the wall 12. Optionally, a sealing member is disposed between the mounting plates 104A.1, 104B.1 and the wall 12, respectively. The cover section 104B can comprise a substantially downward facing inlet opening 174 covered with a screen to protect against blockage due to: inclement weather such as, for example, rain or snow; and animals such as, for example, insects and rodents. Further, the top portion 104A.3 of the elbow section 104A can comprise an inner cross section such that the bottom portion of the wall aerator 102 is accommodated therein via a snug fit to facilitate installation. Optionally, installation is further facilitated by providing an abutting structure for vertically abutting the bottom end of the wall aerator 102. Of course, one skilled in the art will readily arrive at various different designs for providing the convection air to the wall aerator 102.

Optionally, a damper is disposed in the wall aerator 102 enabling aeration of the grain in situations when the storage bin 10 is only partially filled by blocking the convection air flow inside the wall aerator 102 from rising above the fill level as will be described in more detail hereinbelow. A cable 130 for operating the damper can be disposed inside the wall aerator 102 and then guided to the outside via cable guide tube 172, for example, mounted to the elbow section 104A and accommodated in the opening 30 and a respective aperture of the cover section mounting plate 104B.1. Further, the cable guide tube 172 can comprise elbow tube section 172A for changing the orientation of the cable 130. For example, a spring loaded damper is then simply opened by pulling knob 131 mounted to the cable 130. For holding the damper in the open position, the cable 130 is, for example, inserted in cable holding slot 182 of angled cable holding plate 180 which is mounted to the cover section mounting plate 104B.1. The pulling knob 131 is then abutted by the cable holding plate 180 due to the spring tension acting on the cable 130. Optionally, two or more knobs 131 are disposed at predetermined locations along an end portion of the cable 130 in order to enable partial opening of the damper. Of course, one skilled in the art will readily arrive at various different designs for opening and holding the damper in an open or partially open position. For example, the opening and holding the damper in an open or partially open position is also achieved by connecting the cable 130 to a conventional lever mechanism disposed outside the storage bin 10.

The damper can be provided as a damper assembly 120 forming a connecting element for connecting adjacent members of the wall aerator 102, as illustrated in FIGS. 3a and 4c to 4e. The damper assembly 120 comprises a ring structure 122 designed to fit the inside walls of the adjacent members of the wall aerator 102 for having the same mounted thereto in a conventional manner using, for example, sheet metal screws. Flaps 124A, 124B are mounted to axle 126 which is pivotally movable mounted to the ring structure 122 in a conventional manner to enable movement of the flaps between a closed position and an open position as illustrated in FIGS. 4c and 4d, respectively. The flaps 124A, 124B can be held in the closed position using extension spring 132 connected to spring holding structure 140 and flap 124B via U-shaped mounting element 134B. In the closed position the flap 124B is then abutted on surface 144 of the spring holding structure 140. The cable 130 is mounted to the opposite flap 124A in a conventional manner via U-shaped mounting element 134A and guided via ring-shaped cable guide 142 mounted to the spring holding structure 140 in a conventional manner in a direction aligned with a longitudinal axis of the aerator 102. Pulling the cable 130 rotates the flaps 124A, 124B around axis 126 and extends the spring 132. Alternatively, a tension spring is employed with the tension spring being disposed co-axial to the axis 126 and mounted to the ring structure 122 at a first end and to one of the flaps 124A, 124B at a second opposite end.

Further alternatively, the cable 130 is disposed outside the aerator 102 inside or outside the storage bin 10. For example, a lever having the cable 130 attached thereto is mounted to the axle 126 outside the aerator 102 or outside the storage bin 10 with the axle 126 penetrating the back member 112 of the aerator 102 or also penetrating the wall 12 of the storage bin 10.

Of course, one skilled in the art will readily arrive at various different designs for providing the damper and operating the same. For example, the cable 130 is omitted by operating the damper using a solenoid device.

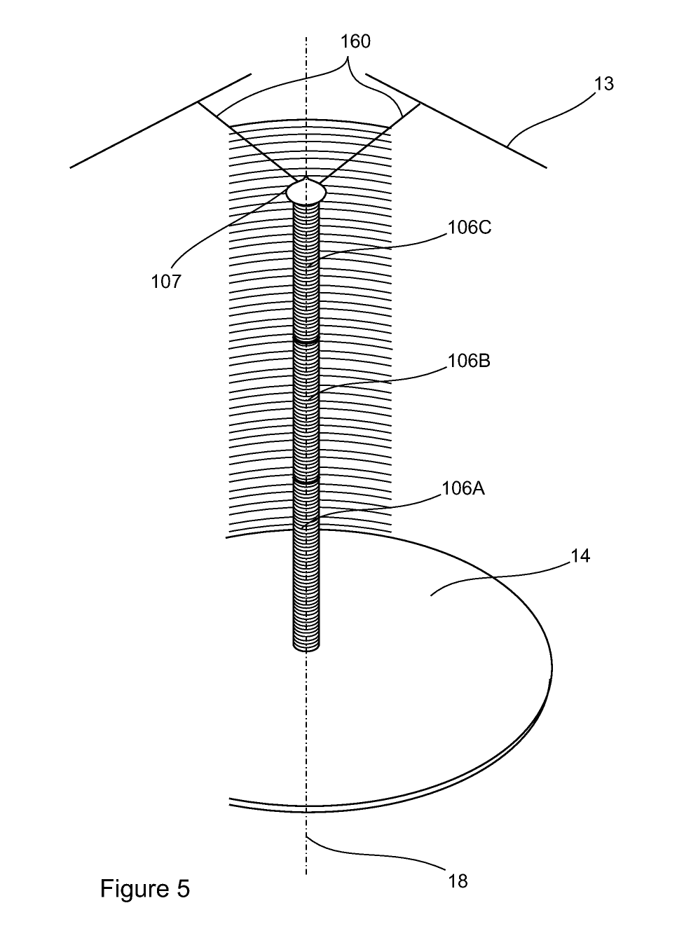

Referring to FIG. 5, an elongated hollow central aerator 106 for being combined with the wall aerators 102 is provided. The central aerator 106 is disclosed, for example, in US Patent Application 2011/0183597. The central aerator 106 is disposed in proximity of the center 18 of the storage bin 10 and oriented substantially vertical. The central aerator 106 has a length approximately equal to a distance between a bottom portion and a top portion of the storage bin 10 and has a plurality of apertures for transmitting air from the particulate materials into the central aerator such as, for example, illustrated in FIGS. 3d and 3e. An opening disposed in a top portion of the central aerator 106 enables transmitting the air from the inside of the central aerator 106 into a top portion of the storage bin 10 through natural convection. The top 107 of the central aerator 106 is mounted to the roof 13 of the storage bin 10 via, for example, chain links 160. The bottom of the central aerator is, for example, supported above the bin floor by means of a conventional support structure specific to flat bottom or hopper bottom grain bins The central aerator 106 can comprise a plurality of connected members such as members 106A, 106B, and 106C, for example.

The present invention has been described herein with regard to certain embodiments. However, it will be obvious to persons skilled in the art that a number of variations and modifications can be made without departing from the scope of the invention as described herein.

What is claimed is:

1. An aeration system for aerating particulate materials disposed in a storage bin comprising:
a plurality of elongated hollow wall aerators, each wall aerator for being disposed inside the storage bin having a substantially vertical orientation and for being mounted adjacent to an inside surface of a wall of the storage bin, each wall aerator having at least an opening for transmitting air from inside the wall aerator to the particulate materials; and,
a plurality of convection air inlets, each convection air inlet being connected to a bottom portion of a respective wall aerator, each convection air inlet for providing outside air to the respective wall aerator through a respective opening disposed in a bottom portion of the storage bin using natural convection.

2. The aeration system according to claim 1 wherein each convection air inlet is adapted for providing outside air through a respective opening disposed in a bottom portion of the wall of the storage bin.

3. The aeration system according to claim 1 wherein a wall of each wall aerator comprises at least a section that is perforated or louvered such that airflow from inside the wall aerator to the particulate materials is enabled while transmission of the particulate materials into the aerator is substantially prevented.

4. The aeration system according to claim 1 wherein each wall aerator comprises at least a bottom member and a top member.

5. The aeration system according to claim 1 wherein each wall aerator comprises at least a damper disposed at a predetermined location between a bottom end and a top end of the aerator.

6. The aeration system according to claim 5 wherein the damper comprises at least a flap pivotally movable between an open position for enabling airflow therethrough and a closed position for substantially blocking the airflow.

7. The aeration system according to claim 6 wherein the damper is spring loaded holding the same in one of the open position and the closed position and wherein the damper comprises a cable for actuating the same, a first end of the cable being connected to the damper and a second end of the cable being disposed outside the storage bin in proximity to a bottom portion thereof with the cable being disposed inside the wall aerator between the damper and the convection air inlet.

8. The aeration system according to claim 1 further comprising:
an elongated hollow central aerator for being disposed in proximity of a center of the storage bin and oriented substantially vertical, the central aerator having a plurality of apertures for transmitting air from the particulate materials into the central aerator and an opening disposed in a top portion thereof for transmitting the air from the inside of the central aerator into a top portion of the storage bin through natural convection; and,
a holding mechanism mounted to the central aerator, the holding mechanism for being mounted to at least one of the top portion and the bottom portion of the storage bin.

9. The aeration system according to claim 8 wherein a wall of the central aerator comprises at least a section that is perforated or louvered such that airflow from the particulate materials into the aerator is enabled while transmission of the particulate materials of is substantially prevented.

10. The aeration system according to claim 8 wherein the central aerator comprises at least a bottom member and a top member.

11. The aeration system according to claim 8 wherein each wall aerator comprises at least a bottom member and a top member.

12. The aeration system according to claim 8 wherein each wall aerator comprises at least a damper disposed at a predetermined location between a bottom end and a top end of the wall aerator.
